(19) United States
(12) Patent Application Publication
(10) Pub. No.: US 2009/0130555 A1
(43) Pub. Date: May 21, 2009

(54) NONAQUEOUS ELECTROLYTE BATTERY

(75) Inventor: Akira Ichihashi, Fukushima (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/254,992

(22) Filed: Oct. 21, 2008

(30) Foreign Application Priority Data
Nov. 16, 2007 (JP) 2007-298128

(51) Int. Cl. H01M 6/16

(52) U.S. Cl. 429/199; 429/206

(57) ABSTRACT

A nonaqueous electrolyte battery includes positive and negative electrodes and an electrolyte, wherein the electrolyte includes succinic anhydride and at least one of lithium difluoro(oxalate)borate presented in Chemical Formula (1) and lithium bis(oxalate)borate presented in Chemical Formula (2).

### CROSS REFERENCES TO RELATED APPLICATIONS

The present application claims priority to Japanese Patent Application JP 2007-298128 filed in the Japanese Patent Office on Nov. 16, 2007, the entire contents of which being incorporated herein by reference.

### BACKGROUND

The present application relates to nonaqueous electrolyte batteries including positive and negative electrodes and nonaqueous electrolytes.

In recent years, portable electronic equipments, typified by camcorders (video tape recorders), mobile phones, and laptop computers, have come into wide use, and the size and weight reduction and long-duration continuous driving of them have been strongly desired. Thus, for power sources, research and development for enhancing the energy densities of batteries, in particular, secondary batteries have been vigorously pursued. Especially, expectations on lithium ion secondary batteries have been placed because they may provide large energy densities as compared to lead batteries and nickel-cadmium batteries, which are nonaqueous electrolytic solution secondary batteries in the past.

In a lithium ion secondary battery, an electrolytic solution is easily decomposed on a negative electrode, resulting in reducing a discharge capacity. Therefore, some methods have been long proposed for improving battery characteristics such as a cycle characteristic.

As a first example, a nonaqueous electrolytic solution battery, in which excessive decomposition of an electrolytic solution in a discharge and charge step is inhibited by adding acid anhydride as a coating-forming ingredient to the electrolytic solution of the nonaqueous electrolytic solution battery, employing a graphite negative electrode, to improve its cycle characteristic, is disclosed in Japanese Patent Application Laid-Open (JP-A) No. 2000-298859.

As a second example, a nonaqueous electrolyte battery, which is improved in lithium ion permeability by adding acid anhydride, and cyclic carbonate having II bonds, to a nonaqueous electrolyte, is disclosed in JP-A No. 2004-22174.

### SUMMARY

In the first example, however, although improvement in resistance to an electrolytic solution allowed improvement in efficiency of discharge and charge, the coating resistance of a coating formed by the acid anhydride was high, resulting in an insufficient cycle characteristic. In the second example, an effect of improvement in the coating resistance was insufficient because, even when succinic anhydride, which is acid anhydride, and vinylene carbonate (VC) were concurrently used, the formation of the coating of the succinic anhydride occurred prior to the formation of the coating of the vinylene carbonate (VC).

Accordingly, it is desirable to provide a nonaqueous electrolyte battery, which may be improved in a cycle characteristic by decreasing coating resistance.

According to an embodiment, there is provided a nonaqueous electrolyte battery including positive and negative electrodes and an electrolyte, wherein the electrolyte includes succinic anhydride and at least one of lithium difluoro (oxalate) borate presented in Chemical Formula (1) and lithium bis (oxalate) borate presented in Chemical Formula (2).

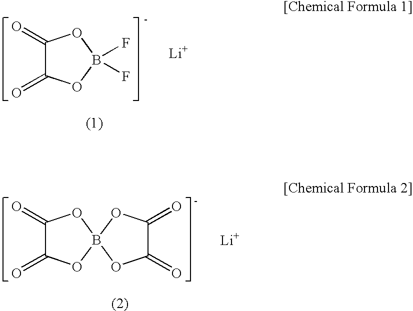

In the present application, coating resistance may be decreased to improve a cycle characteristic by concurrently using succinic anhydride and at least one of lithium difluoro (oxalate) borate presented in Chemical Formula (1) and lithium bis (oxalate) borate presented in Chemical Formula (2).

In the present application, a cycle characteristic may be improved.

Additional features and advantages are described herein, and will be apparent from the following Detailed Description and the figures.

### BRIEF DESCRIPTION OF THE FIGURES

FIG. 1 is a perspective view showing the structure of a nonaqueous electrolyte battery according to an embodiment.

FIG. 2 is a cross-sectional view of a rolled electrode body taken along the line II-II shown in FIG. 1.

### DETAILED DESCRIPTION

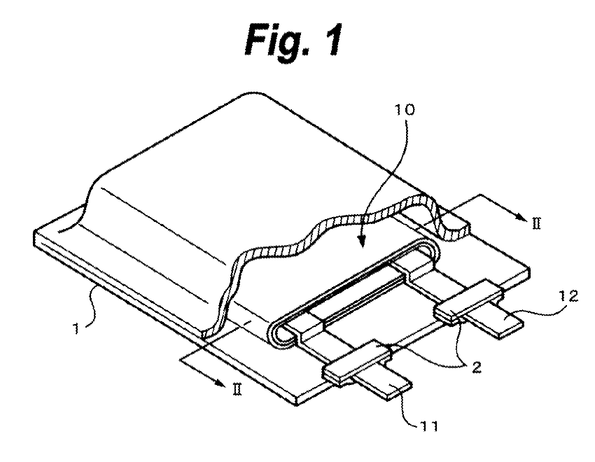

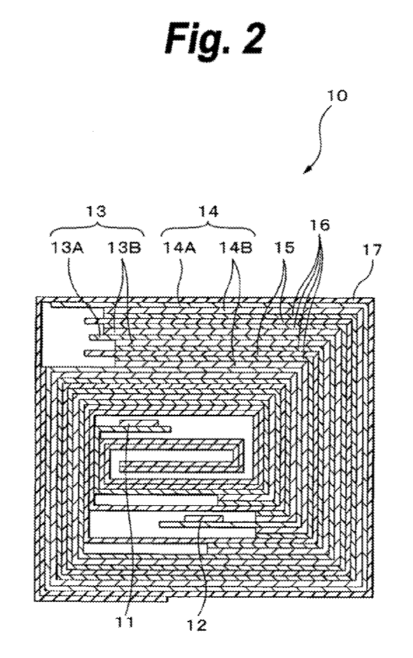

An embodiment of the present application is described below referring to the drawings. First, a configuration example of a nonaqueous electrolyte battery according to an embodiment of the present application is described referring to FIG. 1 and FIG. 2.

FIG. 1 is a perspective view that shows a configuration example of a nonaqueous electrolyte battery according to an embodiment of the present application. The nonaqueous electrolyte battery is, for example, a nonaqueous electrolyte secondary battery. The nonaqueous electrolyte battery has a flat shape, in which a rolled electrode body 10 including a positive electrode lead 11 and a negative electrode lead 12 is stored in an outer jacket 1 with a film shape.

Each of positive and negative electrode leads 11 and 12 has, for example, a strip shape, and is drawn out of the inside to the outside of the outer jacket 1, for example, in the same direction. The positive electrode lead 11 includes a metallic material such as aluminum (Al), and the negative electrode lead 12 includes a metallic material such as nickel (Ni).

The outer jacket 1 is a laminated film having a structure in which, for example, an insulating layer, a metal layer, and an outermost layer are stacked in this order and affixed to each other by, for example, lamination. In the outer jacket 1 including, for example, a side of the insulating layer as an inner side, outer edges are adhered to each other by fusion bond or an adhesive.

The insulating layer includes a polyolefin resin, such as polyethylene, polypropylene, modified polyethylene, modified polypropylene, or copolymers thereof, because it can reduce water permeability and is excellent in airtightness. A metal layer includes aluminum, stainless steel, nickel, or iron in foil or plate form. An outermost layer may include, for example, a resin similar to the insulating layer, or may include nylon, because it can increase resistance to, for example, tearing or stabbing. The outer jacket 1 may include any layer other than the insulating layer, the metal layer, and the outermost layer.

Adherence films 2 for improving adhesiveness of positive and negative electrode leads 11 and 12 with the inside of the outer jacket 1 and preventing intrusion of outside air are inserted between the outer jacket 1 and the positive and negative electrode leads 11 and 12. Preferably, the adherence films 2 include a material having adhesiveness with the positive and negative electrode leads 11 and 12, and, for example, when the positive and negative electrode leads 11 and 12 include the metallic materials, include a polyolefin resin such as polyethylene, polypropylene, modified polyethylene, or modified polypropylene.

FIG. 2 is a cross-sectional view of the rolled electrode body 10 taken along the line II-II of FIG. 1. The rolled electrode body 10 is formed by layering a positive electrode 13 and a negative electrode 14 through the intermediary of a separator 15 and an electrolyte 16, to be rolled, and has an outermost periphery protected by a protective tape 17.

A positive electrode 13 has, for example, a positive electrode collector 13A and positive electrode active material layers 13B disposed on both surfaces of the positive electrode collector 13A. The positive electrode collector 13A includes, for example, metallic foil such as aluminum foil.

A positive electrode active material layer 13B includes, for example, as a positive electrode active material, any one or more of positive electrode materials that can occlude and emit lithium (Li) which is an electrode reaction substance. The positive electrode active material layer 13B may also optionally include a conductant agent such as a carbon material and a binder such as polyvinylidene fluoride.

Adequate examples of positive electrode materials which may occlude and emit lithium include lithium oxide, lithium phosphorus oxide, lithium sulfide, and lithium-containing compounds such as an intercalation compound including lithium, of which two or more may be used in admixture or particles of two or more may be compounded to be used. Also, these materials having the surfaces on which coatings are formed may be used, or these materials of which the particle surfaces are reformed by known methods may be used.

For increasing an energy density, a lithium-containing compound preferably contains lithium, a transition metal element, and oxygen, and in particular, more preferably contains at least one of the group including cobalt (Co), nickel (Ni), manganese (Mn), and iron (Fe) as the transition metal element. Such lithium-containing compounds include, for example, lithium complex oxide having a layered rock-salt structure presented in Chemical Formula I, Chemical Formula II, or Chemical Formula III; lithium complex oxide having a spinel structure presented in Chemical Formula IV; and lithium phosphate compound having an olivine structure presented in Chemical Formula V, and specifically, include LiCoO₂, LiNiO₂, LiMn₂O₄, LiCo_{0.33}Ni_{0.33}Mn_{0.33}O₂, and LiFePO₄.

Li[LiₓMn(_{1-x-y-z})Ni_{y}M1_{z}]O(₂₋ₐ)F_{b} (Chemical Formula I)

wherein M1 is at least one or more elements selected from cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W); x is 0<x≦0.2; y is 0.3≦y≦0.8; z is 0.3≦z≦0.5; a is −0.1≦a≦0.2; and b is 0≦b≦0.1.

Li_{c}Ni_{(1-d)}M2_{d}O₍₂₋ₑ₎F_{f} (Chemical Formula II)

wherein M2 is at least one or more elements selected from cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); c is −0.1≦c≦0.1; d is 0.005≦d≦0.5; e is −0.1≦e≦0.2; and f is 0≦f≦0.1.

Li_{c}Co_{(1-d)}M3_{d}O₍₂₋ₑ₎F_{f} (Chemical Formula III)

wherein M3 is at least one or more elements selected from nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); c is −0.1≦c≦0. 1; d is 0≦d≦0.5; e is −0.1≦e≦0.2; and f is 0≦f≦0.1.

Li₈Mn₍₂₋ₜ₎M4ₜOᵤFᵥ (Chemical Formula IV)

wherein M4 is at least one or more elements selected from cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); s is s≦0.9; t is 0.005≦t≦0.6; u is 3.7≦u≦4.1; and v is 0≦v≦0.1.

LiM5PO₄ (Chemical Formula V)

wherein M5 is at least one or more elements selected from cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), and zirconium (Zr).

A negative electrode 14 as well as a positive electrode 13 has, for example, a negative electrode collector 14A and negative electrode active material layers 14B disposed on both surfaces of the negative electrode collector 14A. The negative electrode collector 14A includes, for example, metallic foil such as copper foil.

A negative electrode active material layer 14B includes, for example, as a negative electrode active material, any one or more of negative electrode materials that can occlude and emit lithium (Li), and may also optionally include a conductive assistant and a binder.

Negative electrode materials that can occlude and emit lithium include, for example, carbon materials such as natural graphite, artificial graphite, graphitizable carbon, and non-graphitizable carbon. Any one of the carbon materials may be used alone, two or more of them may be also used in admixture, or two or more of them of varying mean particle sizes may be also used in admixture.

Negative electrode materials that can occlude and emit lithium also include materials containing metallic elements or metalloid elements, which may be alloyed with lithium, as constituent elements, and in particular, include the elementary substances, alloys, or compounds of metallic elements, which may be alloyed with lithium; the elementary substances, alloys, or compounds of the metalloid elements, which may be alloyed with lithium; and materials at least partially have the phases of one or more thereof.

Such metallic elements or metalloid elements include, for example, tin (Sn), lead (pb), aluminum, indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), or hafnium (Hf). Specifically, metallic elements or metalloid elements of Group 14 of the long-form periodic table are preferred, and in particular, silicon (Si) or tin (Sn) is preferred, because silicon (Si) and tin (Sn) have a high ability to occlude and emit lithium and may provide a high energy density.

Alloys of silicon (Si) include, for example, ones containing, as a second constituent element except silicon (Si), at least one of the group including tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr). Alloys of tin (Sn) include, for example, ones containing, as a second constituent element except tin (Sn), at least one of the group including silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr).

Compounds of silicon (Si) or compounds of tin (Sn) include, for example, ones containing oxygen (O) or carbon (C), and may contain the second constituent elements as well as silicon (Si) or tin (Sn).

Any separator 15 may be used as long as it is chemically stable toward a positive electrode active material, a negative electrode active material, and a solvent as well as electrically stable, and has no electron conductivity. For example, a polymeric non-woven fabric, a porous film, or a papyraceous material made of a glass or ceramic fiber may be used, and a plurality of them may be layered to be used.

An electrolyte 16 contains an electrolytic solution and high molecular compounds holding the electrolytic solution, and is in a so-called gel state. The electrolytic solution include at least one of lithium difluoro(oxalate)borate presented in Chemical Formula (1) and lithium bis(oxalate)borate presented in Chemical Formula (2) and succinic anhydride. High coating resistance due to succinic anhydride may be reduced to improve a cycle characteristic by concurrent use of at least one of lithium difluoro(oxalate)borate presented in Chemical Formula (1) and lithium bis(oxalate)borate presented in Chemical Formula (2), and succinic anhydride.

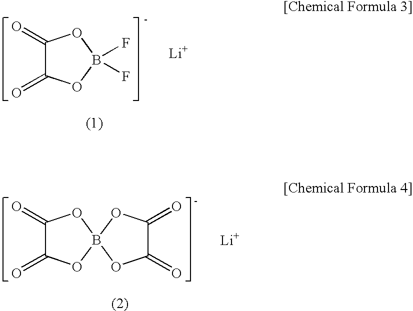

It is preferable to add succinic anhydride of 0.1 wt. % to 1.5 wt. % to an electrolytic solution from the viewpoint of providing more excellent battery characteristics. The total mass of lithium difluoro(oxalate)borate and lithium bis(oxalate)borate is also preferably 10% to 60% to the mass of succinic anhydride from the viewpoint of providing more excellent battery characteristics. Furthermore, it is more preferable that an amount of added succinic anhydride be 0.1 wt. % to 1.5 wt. % to an electrolytic solution and the total mass of lithium difluoro(oxalate)borate and lithium bis(oxalate)borate be 10% to 60% to the mass of succinic anhydride from the viewpoint of providing excellent battery characteristics in particular.

An electrolyte salt preferably further includes a lithium salt such as LiPF₆, LiClO₄, LiBF₄, LiN(CF₃SO₂)₂, LiN(C₂F₅SO₂)₂, or LiAsF₆. Any one of these lithium salts may be used, or two or more of them may be also used in admixture.

Solvents include, for example, a carbonic ester solvent such as ethylene carbonate, propylene carbonate, vinylene carbonate, dimethyl carbonate, ethylmethyl carbonate, or diethyl carbonate; an ether type solvent such as 1,2-dimethoxyethane, 1-ethoxy-2-methoxyethane, 1,2-diethoxyethane, tetrahydrofuran, or 2-methyltetrahydrofuran; a lactone solvent such as γ-butyrolactone, γ-valerolactone, δ-valerolactone, or ε-caprolactone; a nitril solvent such as acetonitrile; a sulfolane solvent; a phosphoric ester solvent such as phosphoric acids; and a nonaqueous solvent such as pyrrolidones. Any one of solvents may be used alone, or two or more of them may be also used in admixture.

Any high molecular compound may be used as long as it absorbs a solvent and gelates. High molecular compounds include, for example, a fluorine-based high molecular compound such as polyvinylidene fluoride or a copolymer of vinylidene fluoride and hexafluoropropylene; an ether-based high molecular compound such as a cross-linked product including polyethylene oxide and polyethylene oxide; and one including polyacrylonitrile and polymethyl methacrylate as a repeating unit. Any one of high molecular compounds may be used alone, or two or more of them may be also used in admixture.

Next, an example of a method of manufacturing a nonaqueous electrolyte battery according to an embodiment of the present application is described. First, for example, positive electrode active material layers 13B are formed on a positive electrode collector 13A to produce a positive electrode 13. The positive electrode active material layers 13B are formed, for example, by mixing a positive electrode active material, a conductant agent, and a binder to be dispersed into a solvent such as N-methyl-2-pyrrolidone (NMP) to be processed to a paste, being followed by applying it to the positive electrode collector 13A, drying it, and compressively forming it.

Also, for example, negative electrode active material layers 14B are formed on a negative electrode collector 14A to produce a negative electrode 14. The negative electrode active material layers 14B are formed, for example, by mixing a negative electrode active material and a binder to be dispersed into a solvent such as N-methyl-2-pyrrolidone (NMP) to be processed to a paste, being followed by applying it to the negative electrode collector 14A, drying it, and compressively forming it. A positive electrode lead 11 is then fitted to a positive electrode collector 13A, and a negative electrode lead 12 is fitted to the negative electrode collector 14A.

An electrolytic solution and a high molecular compound are then mixed using a mixed solvent, this mixed solution is applied onto positive electrode active material layers 13B and negative electrode active material layers 14B, and the mixed solvent is volatilized to form a gelatinous electrolyte 16. A positive electrode 13, a separator 15, a negative electrode 14, and a separator 15 are sequentially layered to be rolled, and a protective tape 17 is adhesively bonded to an outermost periphery to form a rolled electrode body 10, followed by being inserted into the outer jacket 1 to heat-seal the outer peripheral edge of the outer jacket 1. In this step, adherence films 2 are inserted between positive and negative electrode leads 11 and 12 and the outer jacket 1, resulting in providing a nonaqueous electrolyte battery shown in FIG. 1.

A positive and a negative electrode 13 and 14 may be also rolled through the intermediary of a separator 15, to be inserted into the outer jacket 1, followed by injecting an electrolyte composition including an electrolytic solution and the monomer of a high molecular compound to polymerize the monomer in the outer jacket 1, instead of forming an electrolyte 16 on the positive and the negative electrode 13 and 14, followed by being rolled.

### EXAMPLES

Specific examples of the present application are described in detail. However, the present application is not limited only to these examples. In addition, in the following description of the examples, lithium difluoro(oxalate)borate presented in Chemical Formula (1) is appropriately referred to as LiFOB, and lithium bis(oxalate)borate presented in Chemical Formula (2) as LiBOB.

### Examples 1 to 27 and Comparison 1 to Comparison 13

Nonaqueous electrolyte batteries according to Examples

1 to 27 and Comparisons 1 to 13 were produced to assess cycle characteristics as described below.

### Example 1

A LiCoO₂ powder, graphite as a conductant agent, and polyvinylidene fluoride as a binder were mixed at a mass ratio of LiCoO₂ powder:graphite:polyvinylidene fluoride=90:5:5 to prepare a positive electrode mixture. Next, the positive electrode mixture was dispersed into N-methyl-2-pyrrolidone as a solvent to make positive electrode mixture slurry, which was equally applied to both surfaces of a positive electrode collector including belt-shaped aluminum foil with a thickness of 20 μm.

Next, a positive electrode active material layer was formed by compression formation by a roll press machine after a drying step, and then clipped to be 50 mm×350 mm to produce a positive electrode. In addition, an aluminum positive electrode lead was connected to one end of a positive electrode collector.

As a negative electrode active material, meso carbon micro beads (MCMB) and polyvinylidene fluoride (PVdF) as a binder were mixed to prepare a negative electrode mixture. Next, the negative electrode mixture was dispersed into N-methyl-2-pyrrolidone as a solvent to make negative electrode mixture slurry, which was equally applied to both surfaces of a negative electrode collector including belt-shaped copper foil with a thickness of 15 μm.

Next, a negative electrode active material layer was formed by compression formation by a roll press machine after a drying step, and then clipped to be 52 mm×370 mm to produce a negative electrode. Subsequently, a nickel negative electrode lead was connected to one end of a negative electrode collector.

Next, an electrolytic solution was produced by dissolving LiPF₆ in a mixed solvent, in which ethylene carbonate (EC) and propylene carbonate (PC) were mixed at a volume ratio (EC:PC)=40:60, to be 0.7 mol/kg, and further adding LiFOB of 0.03 wt. % and succinic anhydride of 0.5 wt. %.

Next, an electrolytic solution was held in a copolymer of vinylidene fluoride and hexafluoropropylene to be a gelatinous electrolyte. The rate of the hexafluoropropylene to the copolymer was made to be 6.9 wt. %.

A rolled electrode body was made by forming gelatinous electrolytes on both surfaces of the produced positive and negative electrodes, respectively, and layering and rolling them through the intermediary of a separator. Subsequently, the rolled electrode body was sheathed with a laminated film to seal the periphery of the rolled electrode body. As described above, the nonaqueous electrolyte battery according to Example 1 was produced.

### Example 2

The nonaqueous electrolyte battery according to Example 2 was produced by the same method as in Example 1 except that the amount of added LiFOB was 0.05 wt. % in the step of producing an electrolytic solution.

### Example 3

The nonaqueous electrolyte battery according to Example 3 was produced by the same method as in Example 1 except that the amount of added LiFOB was 0.1 wt. % in the step of producing an electrolytic solution.

### Example 4

The nonaqueous electrolyte battery according to Example 4 was produced by the same method as in Example 1 except that the amount of added LiFOB was 0.3 wt. % in the step of producing an electrolytic solution.

### Example 5

The nonaqueous electrolyte battery according to Example 5 was produced by the same method as in Example 1 except that the amount of added LiFOB was 0.35 wt. % in the step of producing an electrolytic solution.

### Example 6

The nonaqueous electrolyte battery according to Example 6 was produced by the same method as in Example 1 except that the LiBOB of 0.03 wt. % was added and no LiFOB was added in the step of producing an electrolytic solution.

### Example 7

The nonaqueous electrolyte battery according to Example 7 was produced by the same method as in Example 6 except that the amount of added LiBOB was 0.05 wt. % in the step of producing an electrolytic solution.

### Example 8

The nonaqueous electrolyte battery according to Example 8 was produced by the same method as in Example 6 except that the amount of added LiBOB was 0.1 wt. % in the step of producing an electrolytic solution.

### Example 9

The nonaqueous electrolyte battery according to Example 9 was produced by the same method as in Example 6 except that the amount of added LiBOB was 0.3 wt. % in the step of producing an electrolytic solution.

### Example 10

The nonaqueous electrolyte battery according to Example 10 was produced by the same method as in Example 6 except that the amount of added LiBOB was 0.35 wt. % in the step of producing an electrolytic solution.

### Example 11

The nonaqueous electrolyte battery according to Example 11 was produced by the same method as in Example 1 except that the amount of added LiFOB was 0.05 wt. % and LiBOB of 0.05 wt. % was added in the step of producing an electrolytic solution.

### Example 12

The nonaqueous electrolyte battery according to Example 12 was produced by the same method as in Example 11 except that the amount of added LiFOB was 0.1 wt. % and the amount of added LiBOB was made to be 0.1 wt. % in the step of producing an electrolytic solution.

### Example 13

The nonaqueous electrolyte battery according to Example 13 was produced by the same method as in Example 11 except that the amount of added LiFOB was 0.15 wt. % and the amount of added LiBOB was 0.15 wt. % in the step of producing an electrolytic solution.

### Example 14

The nonaqueous electrolyte battery according to Example 14 was produced by the same method as in Example 1 except that the amount of added succinic anhydride was 0.05 wt. % and the amount of added LiFOB was 0.02 wt. % in the step of producing an electrolytic solution.

### Example 15

The nonaqueous electrolyte battery according to Example 15 was produced by the same method as in Example 1 except that the amount of added succinic anhydride was 0.1 wt. % and the amount of added LiFOB was 0.04 wt. % in the step of producing an electrolytic solution.

### Example 16

The nonaqueous electrolyte battery according to Example 16 was produced by the same method as in Example 1 except that the amount of added succinic anhydride was 1.5 wt. % and the amount of added LiFOB was 0.6 wt. % in the step of producing an electrolytic solution.

### Example 17

The nonaqueous electrolyte battery according to Example 17 was produced by the same method as in Example 1 except that the amount of added succinic anhydride was 2 wt. % and the amount of added LiFOB was 0.8 wt. % in the step of producing an electrolytic solution.

### Example 18

The nonaqueous electrolyte battery according to Example 18 was produced by the same method as in Example 1 except that the amount of added succinic anhydride was 0.05 wt. %, no LiFOB was added, and LiBOB of 0.02 wt. % was added in the step of producing an electrolytic solution.

### Example 19

The nonaqueous electrolyte battery according to Example 19 was produced by the same method as in Example 18 except that the amount of added succinic anhydride was 0.1 wt. % and the amount of added LiBOB was 0.04 wt. % in the step of producing an electrolytic solution.

### Example 20

The nonaqueous electrolyte battery according to Example 20 was produced by the same method as in Example 18 except that the amount of added succinic anhydride was 1.5 wt. % and the amount of added LiBOB was 0.6 wt. % in the step of producing an electrolytic solution.

### Example 21

The nonaqueous electrolyte battery according to Example 21 was produced by the same method as in Example 18 except that the amount of added succinic anhydride was 2 wt. % and the amount of added LiBOB was 0.8 wt. % in the step of producing an electrolytic solution.

### <Comparison 1>

The nonaqueous electrolyte battery according to Comparison 1 was produced by the same method as in Example 1 except that no succinic anhydride was added and the amount of added LiFOB was 0.5 wt. % in the step of producing an electrolytic solution.

### <Comparison 2>

The nonaqueous electrolyte battery according to Comparison 2 was produced by the same method as in Example 1 except that no succinic anhydride was added and the amount of added LiBOB was 0.5 wt. % in the step of producing an electrolytic solution.

### <Comparison 3>

The nonaqueous electrolyte battery according to Comparison 3 was produced by the same method as in Example 1 except that the amount of added succinic anhydride was 0.1 wt. % and no LiFOB was added in the step of producing an electrolytic solution.

### <Comparison 4>

The nonaqueous electrolyte battery according to Comparison 4 was produced by the same method as in Comparison 3 except that the amount of added succinic anhydride was 0.4 wt. % and vinylene carbonate (VC) of 2 wt. % was added in the step of producing an electrolytic solution.

### <Comparison 5>

The nonaqueous electrolyte battery according to Comparison 5 was produced by the same method as in Comparison 3 except that the amount of added succinic anhydride was 0.5 wt. % in the step of producing an electrolytic solution.

### <Comparison 6>

The nonaqueous electrolyte battery according to Comparison 6 was produced by the same method as in Comparison 3 except that the amount of added succinic anhydride was 1.5 wt. % in the step of producing an electrolytic solution.

### <Comparison 7>

The nonaqueous electrolyte battery according to Comparison 7 was produced by the same method as in Comparison 3 except that the amount of added succinic anhydride was 3 wt. % in the step of producing an electrolytic solution.

### <Comparison 8>

The nonaqueous electrolyte battery according to Comparison 8 was produced by the same method as in Example 1 except that no succinic anhydride was added, maleic anhydride of 0.5 wt. % was added, and the amount of added LiFOB was 0.3 wt. % in the step of producing an electrolytic solution.

### <Comparison 9>

The nonaqueous electrolyte battery according to Comparison 9 was produced by the same method as in Example 1 except that no succinic anhydride was added, glutaric anhydride of 0.5 wt. % was added, and the amount of added LiFOB was 0.3 wt. % in the step of producing an electrolytic solution.

(Assessment of Cycle Characteristic)

Cycle characteristics were assessed as described bellow. Charge/discharge was performed by initially performing a constant voltage and constant current charge of 1 C to an upper limit of 4.2 V for total charge time of 2.5 hours and subsequently performing a constant-current discharge of 1 C to a final voltage 3.0 V. These 300 charge/discharge operations were also repeated. A capacity maintenance rate was determined by a rate of a discharge capacity at 300th cycle to a discharge capacity at first cycle in the following Equation I.

Capacity maintenance rate(%)=(“discharge capacity at 300th cycle”/“discharge capacity at first cycle”)×100(%) (Equation I)

Results of measurements of the nonaqueous electrolyte batteries according to Example 1 to Example 21 and Comparison 1 to Comparison 9 are shown in Table 1.

TABLE 1

| | ACID ANHYDRIDE | | LiFOB | LiBOB | VC | *MASS | CYCLE |
|---|---|---|---|---|---|---|---|
| | TYPE | wt % | [wt %] | [wt %] | [wt %] | RATIO [%] | CHARACTERISTIC [%] |
| EXAMPLE 1 | SUCCINIC ANHYDRIDE | 0.5 | 0.03 | — | — | 6 | 82 |
| EXAMPLE 2 | SUCCINIC ANHYDRIDE | 0.5 | 0.05 | — | — | 10 | 92 |
| EXAMPLE 3 | SUCCINIC ANHYDRIDE | 0.5 | 0.1 | — | — | 20 | 93 |
| EXAMPLE 4 | SUCCINIC ANHYDRIDE | 0.5 | 0.3 | — | — | 60 | 92 |
| EXAMPLE 5 | SUCCINIC ANHYDRIDE | 0.5 | 0.35 | — | — | 70 | 84 |
| EXAMPLE 6 | SUCCINIC ANHYDRIDE | 0.5 | — | 0.03 | — | 6 | 83 |
| EXAMPLE 7 | SUCCINIC ANHYDRIDE | 0.5 | — | 0.05 | — | 10 | 91 |
| EXAMPLE 8 | SUCCINIC ANHYDRIDE | 0.5 | — | 0.1 | — | 20 | 91 |
| EXAMPLE 9 | SUCCINIC ANHYDRIDE | 0.5 | — | 0.3 | — | 60 | 93 |
| EXAMPLE 10 | SUCCINIC ANHYDRIDE | 0.5 | — | 0.35 | — | 70 | 80 |
| EXAMPLE 11 | SUCCINIC ANHYDRIDE | 0.5 | 0.05 | 0.05 | — | 20 | 92 |
| EXAMPLE 12 | SUCCINIC ANHYDRIDE | 0.5 | 0.1 | 0.1 | — | 40 | 94 |
| EXAMPLE 13 | SUCCINIC ANHYDRIDE | 0.5 | 0.15 | 0.15 | — | 60 | 92 |
| EXAMPLE 14 | SUCCINIC ANHYDRIDE | 0.05 | 0.02 | — | — | 40 | 73 |
| EXAMPLE 15 | SUCCINIC ANHYDRIDE | 0.1 | 0.04 | — | — | 40 | 84 |
| EXAMPLE 16 | SUCCINIC ANHYDRIDE | 1.5 | 0.6 | — | — | 40 | 93 |
| EXAMPLE 17 | SUCCINIC ANHYDRIDE | 2 | 0.8 | — | — | 40 | 75 |
| EXAMPLE 18 | SUCCINIC ANHYDRIDE | 0.05 | — | 0.02 | — | 40 | 74 |
| EXAMPLE 19 | SUCCINIC ANHYDRIDE | 0.1 | — | 0.04 | — | 40 | 85 |
| EXAMPLE 20 | SUCCINIC ANHYDRIDE | 1.5 | — | 0.6 | — | 40 | 92 |
| EXAMPLE 21 | SUCCINIC ANHYDRIDE | 2 | — | 0.8 | — | 40 | 74 |
| COMPARISON 1 | — | — | 0.5 | — | — | — | 61 |
| COMPARISON 2 | — | — | — | 0.5 | — | — | 64 |
| COMPARISON 3 | SUCCINIC ANHYDRIDE | 0.1 | — | — | — | — | 63 |
| COMPARISON 4 | SUCCINIC ANHYDRIDE | 0.4 | — | — | 2 | — | 64 |
| COMPARISON 5 | SUCCINIC ANHYDRIDE | 0.5 | — | — | — | — | 61 |
| COMPARISON 6 | SUCCINIC ANHYDRIDE | 1.5 | — | — | — | — | 62 |
| COMPARISON 7 | SUCCINIC ANHYDRIDE | 3 | — | — | — | — | 62 |
| COMPARISON 8 | MALEIC ANHYDRIDE | 0.5 | 0.3 | — | — | — | 62 |
| COMPARISON 9 | GLUTARIC ANHYDRIDE | 0.5 | 0.3 | — | — | — | 66 |

*MASS RATIO = [(LiFOB MASS + LiBOB MASS)/(SUCCINIC ANHYDRIDE MASS)] × 100

As shown in Table 1, obtained cycle characteristics in Example 1 to Example 21 using an electrolytic solution including succinic anhydride and at least one of lithium difluoro(oxalate)borate and lithium bis(oxalate)borate were superior to those in Comparison 1 to Comparison 4 and Comparison 7 to Comparison 9.

It was clear from Example 1 to Example 5 that a superior cycle characteristic was obtained when the mass ratio of LiFOB to succinic anhydride ranged from 10% to 60%. It was also clear from Example 6 to Example 10 that a superior cycle characteristic was obtained when the mass ratio of LiBOB to succinic anhydride ranged from 10% to 60%. A superior cycle characteristic could be confirmed to be obtained in Example 11 to Example 13 in which the total mass ratio of LiFOB and LiBOB to succinic anhydride ranged from 10% to 60%.

It was clear from Example 14 to Example 17 that a superior cycle characteristic was obtained when the amount of added succinic anhydride was 0.1 wt. % to 1.5 wt. %. It was clear from Example 18 to Example 21 that a superior cycle characteristic was obtained when the amount of added succinic anhydride was 0.1 wt. % to 1.5 wt. %.

### Examples 22 to 27 and Comparison 10 to Comparison 13

In order to assess characteristics due to the content of propylene carbonate (PC) in a solvent, nonaqueous electrolyte batteries according to Examples 22 to 27 and Comparison 10 to Comparison 13 were produced.

### Examples 22

The nonaqueous electrolyte battery according to Example 22 was produced by the same method as in Example 4.

### Examples 23

The nonaqueous electrolyte battery according to Example 23 was produced by the same method as in Example 9.

### Examples 24

The nonaqueous electrolyte battery according to Example 24 was produced by the same method as in Example 22 except that ethylene carbonate (EC) and propylene carbonate (PC) were mixed at a volume ratio of (EC:PC)=30:70 in the step of producing an electrolytic solution.

### Examples 25

The nonaqueous electrolyte battery according to Example 25 was produced by the same method as in Example 23 except that ethylene carbonate (EC) and propylene carbonate (PC) were mixed at a volume ratio of (EC:PC)=30:70 in the step of producing an electrolytic solution.

### Examples 26

The nonaqueous electrolyte battery according to Example 26 was produced by the same method as in Example 22 except that ethylene carbonate (EC) and propylene carbonate (PC) were mixed at a volume ratio of (EC:PC)=20:80 in the step of producing an electrolytic solution.

### Examples 27

The nonaqueous electrolyte battery according to Example 27 was produced by the same method as in Example 23 except that ethylene carbonate (EC) and propylene carbonate (PC) were mixed at a volume ratio of (EC:PC)=20:80 in the step of producing an electrolytic solution.

### <Comparison 10>

The nonaqueous electrolyte battery according to Comparison 10 was produced by the same method as in Example 24 except that no succinic anhydride was added and vinylene carbonate (VC) of 2 wt. % was added in the step of producing an electrolytic solution.

### <Comparison 11>

The nonaqueous electrolyte battery according to Comparison 11 was produced by the same method as in Example 25 except that no succinic anhydride was added and vinylene carbonate (VC) of 2 wt. % was added in the step of producing an electrolytic solution.

### <Comparison 12>

The nonaqueous electrolyte battery according to Comparison 12 was produced by the same method as in Example 26 except that no succinic anhydride was added and vinylene carbonate (VC) of 2 wt. % was added in the step of producing an electrolytic solution.

### <Comparison 13>

The nonaqueous electrolyte battery according to Comparison 13 was produced by the same method as in Example 27 except that no succinic anhydride was added and vinylene carbonate (VC) of 2 wt. % was added in the step of producing an electrolytic solution.

Cycle characteristics in accordance with Example 22 to Example 27 and Comparison 10 to Comparison 13 were assessed. Results of measurements are shown in Table 2.

TABLE 2

| | SOLVENT | | | | | | | | |
|---|---|---|---|---|---|---|---|---|---|
| | (VOLUME | | | | | | | | CYCLE |
| | RATIO) | | ACID ANHYDRIDE | | LiFOB | LiBOB | VC | *MASS | CHARACTERISTIC |
| | EC | PC | TYPE | wt % | [wt %] | [wt %] | [wt %] | RATIO [%] | [%] |
| EXAMPLE 22 | 40 | 60 | SUCCINIC ANHYDRIDE | 0.5 | 0.3 | — | — | 60 | 92 |
| EXAMPLE 23 | 40 | 60 | SUCCINIC ANHYDRIDE | 0.5 | — | 0.3 | — | 60 | 93 |
| EXAMPLE 24 | 30 | 70 | SUCCINIC ANHYDRIDE | 0.5 | 0.3 | — | — | 60 | 92 |
| EXAMPLE 25 | 30 | 70 | SUCCINIC ANHYDRIDE | 0.5 | — | 0.3 | — | 60 | 92 |
| EXAMPLE 26 | 20 | 80 | SUCCINIC ANHYDRIDE | 0.5 | 0.3 | — | — | 60 | 92 |
| EXAMPLE 27 | 20 | 80 | SUCCINIC ANHYDRIDE | 0.5 | — | 0.3 | — | 60 | 92 |
| COMPARISON 10 | 30 | 70 | — | — | 0.3 | — | 2 | — | 65 |
| COMPARISON 11 | 30 | 70 | — | — | — | 0.3 | 2 | — | 67 |
| COMPARISON 12 | 20 | 80 | — | — | 0.3 | — | 2 | — | 48 |
| COMPARISON 13 | 20 | 80 | — | — | — | 0.3 | 2 | — | 52 |

*MASS RATIO = [(LiFOB MASS + LiBOB MASS)/(SUCCINIC ANHYDRIDE MASS)] × 100

As shown in Table 2, in accordance with Example 22 to Example 27, even when a rate of propylene carbonate (PC) content was increased, the cycle characteristics were approximately comparable. In contrast, in accordance with Comparison 10 to Comparisons 13, cycle characteristic deterioration was enhanced with increasing the rate of propylene carbonate (PC) content. More specifically, it was clear that an effect of improvement in cycle characteristic provided by concurrent use of succinic anhydride and at least one of LiFOB and LiBOB was enhanced with increasing the rate of propylene carbonate (PC) content.

The present application is not to be limited to the above-mentioned embodiments according to the present application. It should be understood by those skilled in the art that various modifications, combinations, sub-combinations and alterations may occur depending on design requirements and other factors insofar as they are within the scope of the appended claims or the equivalents thereof. In an embodiment, for example, a nonaqueous electrolyte secondary battery having a gelatinous electrolyte has been described, but the present application is not limited thereto. For example, the present application is applicable to a liquid-based nonaqueous electrolyte secondary battery. Its shape is not also limited in particular and may be also a cylindrical, square, coin, or button shape.

Furthermore, in the above-mentioned embodiments and examples, a nonaqueous electrolyte secondary battery, in which the capacity of a negative electrode is presented according to capacity components based on occlusion and emission of lithium, a so-called lithium ion secondary battery has been described, but the present application is also similarly applicable to a so-called lithium metal secondary battery, in which lithium metal is used in a negative electrode active material and the capacity of the negative electrode is presented according to capacity components based on precipitation and dissolution of lithium, or a secondary battery, in which the capacity of the negative electrode includes the capacity components based on the occlusion and emission of lithium and the capacity components based on the precipitation and dissolution of lithium and is presented by the sum thereof due to making the charge capacity of a negative electrode material, which can occlude and emit lithium, smaller than that of a positive electrode.

Furthermore, for example, a method of producing positive and negative electrodes is not limited to the above-mentioned examples. Methods to be adopted include, but is not limited to, for example, a method of adding, for example, a known binder to a material to be heated and applied, and a method of treatment, such as formation, of a material alone or mixed with a conductive material and, in addition, a binder, and producing a formed electrode on a collector. More specifically, slurry mixed with, for example, the binder and an organic solvent may be made, followed by being applied onto a collector and drying it, to produce them. Alternatively, the pressurization and formation of an active material while being heated, with or without the binder, also allows production of an electrode having a height. Furthermore, for example, an active material layer to be placed on the collector may also include a plurality of layers.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A nonaqueous electrolyte battery comprising:
positive and negative electrodes; and
an electrolyte,
wherein the electrolyte includes succinic anhydride and at least one of lithium difluoro(oxalate)borate presented in Chemical Formula (1) and lithium bis(oxalate)borate presented in Chemical Formula (2):

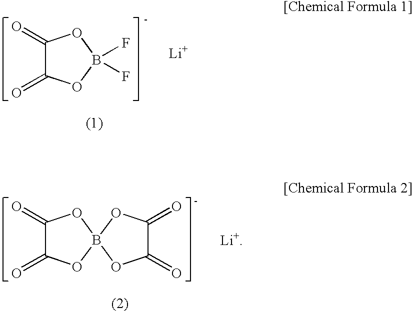

2. The nonaqueous electrolyte battery according to claim 1, wherein an amount of the succinic anhydride ranges from 0.1 wt. % to 1.5 wt. %.

3. The nonaqueous electrolyte battery according to claim 1, wherein a total mass of the lithium difluoro(oxalate)borate and the lithium bis(oxalate)borate ranges from 10% to 60% with respect to a mass of the succinic anhydride.

4. The nonaqueous electrolyte battery according to claim 1, wherein an amount of the added succinic anhydride ranges from 0.1 wt. % to 1.5 wt. % and a total mass of the lithium difluoro(oxalate)borate and the lithium bis(oxalate)borate ranges from 10% to 60% with respect to a mass of the succinic anhydride.
